(19) United States
(12) Patent Application Publication
(10) Pub. No.: US 2004/0049310 A1
(43) Pub. Date: Mar. 11, 2004

(54) Method of displaying content of defective weaving of a loom and display unit for displaying content of defective weaving of the loom

(76) Inventors: Hitoshi Morimoto, Kanazawa-shi (JP); Kazuaki Nozaki, Kanazawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/642,489

(22) Filed: Aug. 18, 2003

(30) Foreign Application Priority Data
Sep. 6, 2002 (JP) 2002-261288

(51) Int. Cl. G06F 19/00

(52) U.S. Cl. 700/140

(57) ABSTRACT

In cases where a defective weaving caused by yarns occurs during operations of a loom, a real cause of defect is identified as to whether it arises from yarns or from setting of the devices on the loom. A display unit of a loom for switching operation modes of a plurality of devices on the loom in response to the rotation of a main shaft of the loom comprises a sensor for detecting a defective weaving, a counter for counting weft picking number with the rotation of the main shaft of a loom, a operation signal generation means for outputting operation signals to the plurality of devices on the loom, in response to the weft picking number and set operation modes, and a display means for displaying information concerning content of defective weaving which is detected by a sensor and information concerning operation signals when the defective weaving occurs.

### FIELD OF THE INVENTION

The invention relates to a method of and a display unit for displaying a content of weaving in defect (hereinafter referred to as content of defective weaving) during weaving of a loom.

### BACKGROUND OF THE INVENTION

When a loom is stopped, it has been notified to an operator by lighting up a lamp of a tower lamp with respect to each cause of stoppage of the loom which is, for example, disclosed in Japanese Patent Laid-Open Publication No. S50-6865. Further, there has been attempted to display causes of the stoppage of the loom on a display by means of characters or illustration in addition to the display by means of the lamp, which is for example disclosed in Japanese Patent Laid-Open Publication No. S50-157651 and Utility Model Laid-open Publication No. H5-30185.

Further, information concerning the selected wefts is also displayed at the time of stoppage of wefts according to a loom into which different kind of wefts are inserted. Accordingly, an operator can identify the weft at the time of occurrence of stoppage of the wefts. Still further, the causes of the stoppage of the loom are transferred to an administration computer of the loom, wherein the types of causes of the stoppage of the loom, times of occurrence of the stoppage of the loom and times of restarting of the loom are stored, which is disclosed, for example, in Japanese Patent Laid-Open Publication Nos. S56-43450 and S62-257445.

According to the prior art, only the cause of stoppage and the matter incident thereto are displayed resulting in lack of information, and hence it takes time to identify a real cause. For example, when there occurs frequent mispick, it is contemplated to be cased by defective quality of wefts, inadequate setting of a picking device, inadequate setting concerning warps, inadequate setting of warp tension, and inadequate setting of selvage forming device, and troubles of these devices.

The causes are relatively easily identified according to a relatively plain fabric while the adjustment of the loom is difficult for a complex fabric such as dobby weaving or a loom in which the revolution is set to a high revolution speed for enhancing productivity, and hence it takes time to identify a real cause. Accordingly, adjustment and operations of the loom are repeated until a real cause of the stoppage of the loom is identified. As a result, the loom needs to keep operating while an operation rate of the loom is not in good order until the real cause is found, which arises a problem that a productivity of a cloth or a quality of the cloth is remarkably lowered as the identification of causes of the stoppage of the loom is delayed.

### SUMMARY OF THE INVENTION

In cases where a defective weaving caused by yarns occurs during operations of a loom, a real cause of defect is identified as to whether it arises from yarns or from setting of the devices on the loom.

To achieve the above object, by displaying a content of defective weaving, and information concerning operation modes of devices on the loom when the defective weaving resulting in the defective fabric occurs during the weaving operation, the invention can easily identify the real cause of the defect arising from yarns or from setting of the devices on the loom based on the content of the display. The defective weaving set forth above means at least one of the defect caused by wefts or warps, more in detail, stoppage of wefts (mispick), at least one of stoppage of warps (breakage of warps), breakage of selvage, breakage of a catch cord.

This is described more in detail. A method of displaying defective content of a loom for switching operation modes of devices (17, 18, 19, 20) on the loom in response to the weft picking number, according to the first aspect of the invention, is characterized in that information concerning defective weaving when it occurs during weaving and information concerning operation modes of the devices (17, 18, 19, 20) on the loom when the defective weaving occurs are displayed. The information concerning operation modes is the weft picking number when the defective weaving occurs, or a content of operation instruction output to the devices (17, 18, 19, 20) on the loom when the defective weaving occurs.

A display unit (1) of a loom for switching operation modes of devices (17, 18, 19, 20) on the loom in response to the rotation of a main shaft (6) of the loom according to the fourth aspect of the invention, characterized in comprising an operation signal generation means (8) including an operation signal generation device (16) for generating operation signals in response to operation modes of the devices (17, 18, 19, 20) on the loom based on the weft picking number which is counted with the rotation of the main shaft (6) of a loom, and a display means (4) for displaying information concerning content of defective weaving which is detected by a sensor (3) and information concerning operation modes of the devices (17, 18, 19, 20) on the loom. The information concerning operation modes displayed by the display means (4) is the weft picking number when the defective weaving occurs.

The display unit (1) of a loom according to the sixth aspect of the invention is characterized in that the operation signal generation device (16) outputs operation signals to the devices (17, 18, 19, 20) in response to the operation modes which are set corresponding to the weft picking number, and the devices (17, 18, 19, 20) are structured to switch the operation modes in response to the operation signals, while the display means (4) reads the operation signals from the operation signal generation device (16) when the sensor (3) detects the defective weaving when the defective weaving occurs and displays it as the information concerning the operation modes. The display means 4 displays the content of the operation signals supplied from the operation signal generation device (16) to the devices (17, 18, 19, 20) on the same screen, said devices (17, 18, 19, 20) are switched in operation modes in response to the operation signals.

A display unit (1) of a loom for switching operation modes of devices (17, 18, 19, 20) on the loom in response to the rotation of a main shaft (6) of the loom according to the eighth aspect of the invention is characterized in comprising an operation signal generation means (8), storing means (5) capable of storing a information concerning content of defective weaving and information concerning operation modes of the devices (17, 18, 19, 20) on the loom which are detected by the sensor (3), respectively, by multiple number of times, and display means (4) for reading out and displaying thereon the content of defective weaving and information concerning operation modes of the devices (17, 18, 19, 20) on the loom. The display means 4 displays the information concerning operation modes of the devices (17, 18, 19, 20) on the loom when the defective weaving occurs and information concerning operation modes immediately before the defective weaving occurs, respectively when the sensor (3) detects the information concerning content of defective weaving.

### BRIEF DESCRIPTION OF THE DRAWINGS

FIG. 1 is a block diagram showing a display unit for displaying content of defective weaving of a loom according to the invention;

FIG. 2 is a view showing an explanation of an example of display illustrating causes of stoppage of a loom; and

FIG. 3 is a view showing an explanation of an example of display illustrating a history of the stoppage of the loom.

### PREFERRED EMBODIMENT OF THE INVENTION

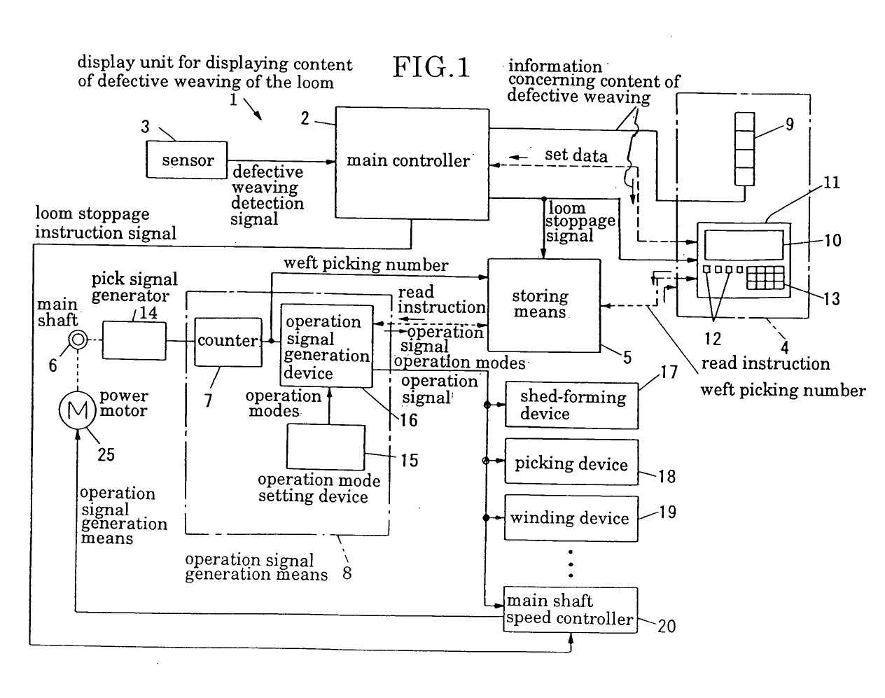

FIG. 1 shows a display unit for displaying content of defective weaving of a loom (hereinafter referred to as display unit) 1 according to the invention. In FIG. 1, the display unit 1 comprises a sensor 3, operation signal generation means 8, storing means 5, display means 4 in a loom provided with a shed-forming device 17, a picking device 18, a winding device 19, a main shaft speed controller 20, which are switched therein in operation modes when a main shaft 6 rotates.

The sensor 3 comprises at least one of various sensors such as an H1 feeler for detecting mispick, an H2 feeler for detecting jumping of wefts, a dropper for detecting breakage of warps, breakage of selvage, breakage of yarns of a catch cord, wherein the defective weaving during weaving operation is detected and defective weaving detection signals are generated when the defective weaving occurs, and the defective weaving detection signals are supplied to a main controller 2.

The operation signal generation means 8 comprises a counter 7 for counting picking signals which are output from a pick signal generator 14 when the main shaft 6 of the loom rotates, an operation signal generation device 16 for generating operation signals to be supplied to the shed-forming device 17, the picking device 18, the winding device 19 and the main shaft speed controller 20 provided on the loom, respectively, upon receipt of the signals of the number of insertion of wefts (hereinafter referred to as weft picking number) from the counter 7, and an operation mode setting device 15 for setting operation modes relative to the shed-forming device 17, the picking device 18, the winding device 19 and the main shaft speed controller 20. Data of operation modes which are differentiated in the weft picking number depending on the kind of fabrics are input in advance to the operation mode setting device 15 by an operator, and these data are input to the operation signal generation device 16 during the operation of the loom. The pick signal generator 14 is coupled to the main shaft 6.

The storing means 5 receives and stores weft picking number from the counter 7 and a loom stoppage signal from the main controller 2 as a content of a defective weaving which is defected by the sensor 3, and further stores operation signals (operation instruction content) of the latest and the last multiple times of operations which are output from the operation signal generation device 16 as information concerning operation modes for every shed-forming device 17, picking device 18, winding device 19, main shaft speed controller 20 and supplies the storage content to data setting device 11 of the display means 4 in response to a read instruction output from the display means 4. The counter 7 increments a count value of the weft picking number one by one in response to a pick signal which is input thereto every time the main shaft 6 of the loom rotates when the main shaft 6 of the loom normally rotates, and returns the count value to 1 when the count value exceeds a set upper limit step number. In FIG. 1, although the counting of the picking umber is carried out by the counter 7 which is separately disposed, it may be structured that such a counting can be effected inside the operation signal generation device 16.

The display means 4 includes the data setting device 11 and a tower lamp 9 for reading and displaying operation signals as the content of defective weaving from the storing means 5 when the sensor 3 detects the defective weaving and information concerning operation modes for every shed-forming device 17, picking device 18, winding device 19, and main shaft speed controller 20. The data setting device 11 of the display means 4 includes a screen display unit 10, a plurality of press buttons 12, ten key 13 and the like, so as to display information concerning operation modes when defective weaving occurs and information concerning operation modes immediately before the defective weaving occurs on the same screen.

The tower lamp 9 receives information concerning content of defective weaving from the main controller 2 and lights up different colored lamps every time the loom stops, weft stops and warp stops. The display modes of the display means 4 includes the display, for example, by printing on a paper, and display on a screen of a display of an administration computer after transferring data to the administration computer and a display in printing by a printer of the administration computer in addition to the display by the tower lamp 9 or by a screen display unit 10.

Meanwhile, the shed-forming device 17 according to this embodiment is a dobby shed-forming device 17 which is a so-called electric dobby for electrically selecting warp shedding operation, and it has an electric dobby controller serving as an operation signal generating means for instructing selection of a heddle frame. The electric dobby controller counts the weft picking number and controls the shed-forming device 17 and picking device 18 in accordance with the selection pattern of the heddle frame. Accordingly, the operation signal generation means 8 is advantageous provided that it is structured by the electric dobby controller while utilizing the function thereof, but it can be structured as an exclusive purpose.

The main controller 2 controls the entire operation of the loom, and generates a loom stoppage signal immediately after receiving the defective weaving detection signal from the sensor 3, and supplies the loom stoppage signal to the storing means 5 and the data setting device 11, and also supplies the loom stoppage signal to the main shaft speed controller 20 as a loom stoppage instruction signal, thereby stopping a power motor 25 for driving the main shaft 6 of the loom while utilizing the stoppage of actuation, speed control, and the braking function of the main shaft speed controller 20, respectively.

Although the main controller 2, the operation signal generation means 8, the storing means 5 and the like are structured to have respective circuits having independent functions according to the embodiment in FIG. 1, functions of these circuits can be realized by use of a micro-processor, namely, by processing on a software of the microprocessor. Accordingly, the circuit configuration is not limited to that shown in FIG. 1.

An operation of the display unit 1 when the defective weaving occurs is now described. The defective weaving means at least one of the defect caused by wefts or warps, more in detail, stoppage of wefts (mispick), at least one of stoppage of warps (breakage of warps), breakage of selvage, breakage of a catch cord.

When the defective weaving occurs during weaving operation, the sensor 3 detects this defective weaving, and generates the defective weaving detection signal and supplied to the main controller 2. The main controller 2 supplies the loom stoppage instruction signal to the main shaft speed controller 20 upon receipt of the defective weaving detection signal, thereby stopping the power motor 25, and also supplies the loom stoppage signal to the data setting device 11 and the storing means 5 in preparation to display when the loom stops.

The storing means 5 stores the weft picking number of the last multiple times of the operations at the time of the occurrence of defective weaving and operation signals which are supplied from the operation signal generation device 16 as information concerning operation modes of the last multiple times of the operations of every shed-forming device 17, the picking device 18, the winding device 19 and the main shaft speed controller 20 corresponding to the weft picking number upon receipt of the loom stoppage signal. The main controller 2 supplies the information concerning content of defective weaving to the tower lamp 9 and the data setting device 11. The tower lamp 9 lights up a lamp of a plurality of lamps corresponding to the content of defective weaving in accordance with information concerning content of defective weaving. As a result, an operator can directly recognize the occurrence of defective weaving and the content of defective weaving.

Meanwhile, the data setting device 11 supplies a read instruction to the storing means 5 upon receipt of the loom stoppage signal from the main controller 2, and reads the weft picking number of the latest and the last multiple times of operations when the defective weaving occurs and information concerning the operation modes corresponding thereto which are stored in the storing means 5, respectively, and displays them together with the content of defective weaving which is received from the main controller 2 on the screen display unit 10 of the data setting device 11.

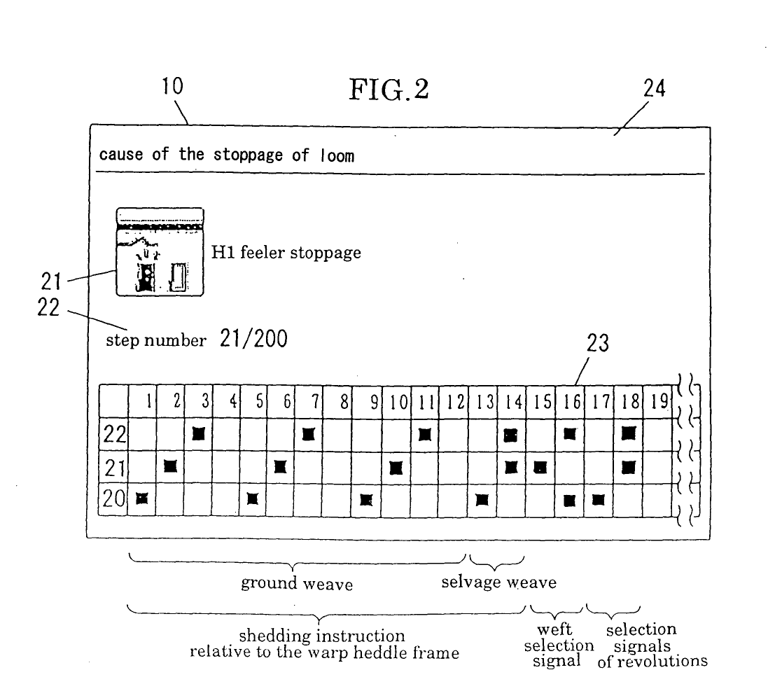

FIG. 2 shows an example of display of the content of defective weaving as the cause of the stoppage of the loom on the screen display unit 10. In the example of this display, the display screen comprises a content of defective weaving display 21, a step number (weft picking number) display 22, an operation mode information weaving display 23 and loom stoppage time display 24.

The content of defective weaving display 21 displays the content of detected defective weaving by illustration and character information. The content of defective weaving is displayed based on information concerning the content of defective weaving from the main controller 2. The content of defective weaving display 21 may display either the illustration and character information in addition to the display of both the instruction and the character information at the same time as the display of this example. The content of defective weaving may be output by voice in addition to the lighting by the tower lamp 9 and the display on the screen display unit 10.

Further, the step number display 22 displays the weft picking number when the defective weaving occurs and the weft picking number in the entire process wherein the former is represented by the numerator and the latter is represented by the denominator. The loom stoppage time display 24 shown on the upper right of the screen represents the time elapsed from the loom stoppage time.

Further, the operation mode information weaving display 23 displays the content of the operation signals, serving as information concerning operation modes corresponding to the weft picking number in the multiple number of operations for every multiple devices on the loom (the shed-forming device 17, picking device 18, winding device 19 and main shaft speed controller 20) which are switched in operation modes and controlled by the operation signal generation means 8, on the screen display unit 10 of the display means 4 in block.

In this embodiment, the vertical cells at the leftmost side of the operation mode information weaving display 23 represents a step number wherein depicted by “22” represents the weft picking number at one step after the occurrence of the cause of the stoppage of the loom, and “21” represents the weft picking number at the time of the occurrence of the cause of the stoppage of the loom and “20 represents at one step before the occurrence of the cause of the stoppage of the loom. The uppermost lateral cells of the operation mode information weaving display 23 represents operation modes (operation signals) corresponding to the step number (weft picking number). Depicted by “1” to “12” in the lateral cells represent a shedding instruction relative to the warp (ground warp) heddle frame number in the shed-forming device 17, “13” and “14” represent a shedding instruction relative to the warp (selvage weave) heddle frame number in the shed-forming device 17, while each black square in each cell represents the upper side shedding in the heddle frame and the blank cell represents the lower side shedding. Depicted by “15”, “16”, represent weft selection signal of a color 1 and a color 2 in the picking device 18 having two different wefts, and each black square represents selection state and each blank represents not-selection state. Depicted by “17” and “18” represent selection signals of high revolution and low revolution relative to the main shaft speed controller 20 and each black square represents selection state of high and low revolutions, respectively, and each blank represents non-selection state. Further, although the lateral cells succeeding after the cell 19 represents operation signals needed for controlling the device on the loom such as a fabric weave instruction (for example, switching instruction in a pile weaving in the ground weaving in the pile loom, idle weaving instruction), but they are omitted in this figure.

Meanwhile, when the loom stops owing to the occurrence of any of the causes of the stoppage of the loom, an operator can recognize that the mispick has occurred during the weft insertion of the color 1 based on the display on the screen display unit 10, namely, “H1 feeler stoppage color 1” in the display 12 of content of defective weaving, and the occurrence of the mispick during the weft insertion at the step number 21 based on the display on the step number display 22, namely, “21/200”. Accordingly, the operator conjectures the inclination of stoppage of the loom based on his memory of the past stoppage condition of the loom and the step number at that time. For example, the operator interprets as to whether the mispick which is the present cause of stoppage of the loom frequently occurs or not at a specific step number and if the operator finally decides that the cause of the stoppage of the loom continuously occur at the specific step number, it is conjectured that the true cause of the stoppage of the loom is affected to some extent by the device which is switched in the operation modes at this step number, namely, by switching the shed states of the warp including the ground weave or selvage weave, or by switching of the revolution of the loom from a high revolution of the loom to the low revolution of the loom, and hence the operator can quickly check the presence of anomaly and the setting condition by making a short list of the shed state of the warp including selvage, and shed-forming device of the warp and the main shaft speed controller. Accordingly, it is possible to prevent in advance the drawback that the productivity of the cloth is significantly reduced and the quality of the fabric are significantly deteriorated, which arise from the continuous operation of the loom while the real cause of the stoppage of the loom is not identified.

According to the example of the shown in FIG. 2, operation modes corresponding to the step number when the defective weaving occurs (step number “21” in this example) and one pick before or after are displayed. According to such a display, the switching operation modes can be easily comprehended, but the only operation modes corresponding to the step number when the defective weaving occurs may be displayed, if the display has to be simplified. Further, the operation mode information weaving display 23 may display only the devices which are actually switched in operation modes at least by the operation signal generation means 8 (operation signal generation device 16) of a plurality of devices on the loom by omitting the devices on the loom which are not actually selected in the weaving process. Further more, both the content of defective weaving display 21 and the operation mode information weaving display 23 may be displayed in block or selectively displayed.

Since the content of defective weaving can be recognized by the tower lamp 9 as set forth above, only the step number display 22 and the operation mode information weaving display 23 may be displayed on the screen display unit 10 while omitting the content of defective weaving display 21.

In the case where the content of defective weaving is the weft stoppage, the weft insertion condition (jetting timing of a weft insertion nozzle and a pressure) and weft running path condition (shedding amount of a warp, a warp tension, a revolution of loom and the like) are displayed on the screen display unit 10, while in the case where the content of defective weaving is the warp stoppage, the warp running path condition may be displayed on the screen display unit 10 as the weaving condition display, in addition to the foregoing display, respectively.

The shown in the screen display unit 10 may be made such that the step number display 22 and the operation mode information weaving display 23 are displayed on the screen display unit 10 in this order by operating the press buttons 12 of the data setting device 11 after the content of defective weaving display 21 is first displayed, and the display may be automatically switched at regular time intervals in addition to the case where the content of defective weaving display 21, the step number display 22, and the operation mode information weaving display 23 are displayed on the same screen as shown in the example of display in FIG. 2,

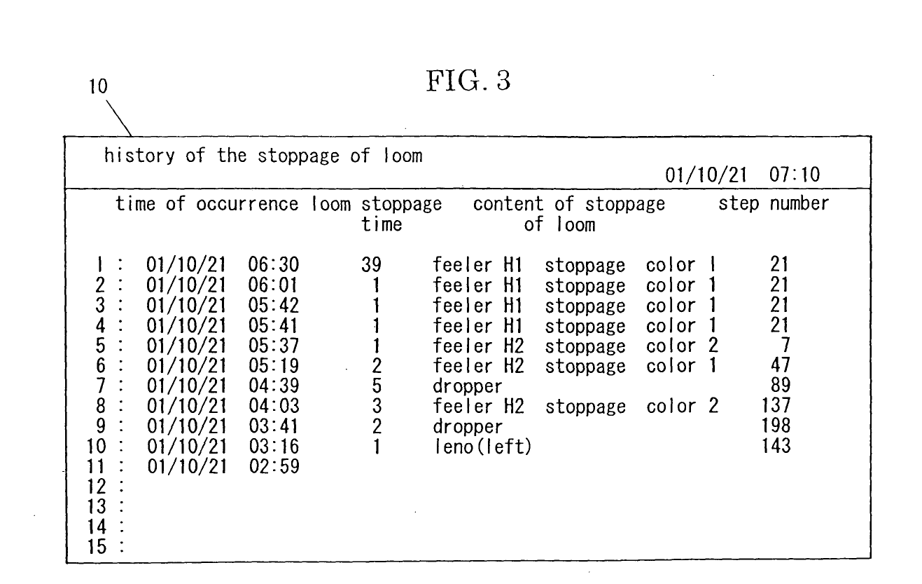

Next, FIG. 3 shows an example for displaying the content of defective weaving of the last multiple times of operations and the like in block, as a “loom stoppage history” in addition to the content of defective weaving when the defective weaving of the loom occurs. In this case, the storing means 5 is configured such that it can store the past content of defective weaving of the loom of the last multiple times of operations. When an operator operates the data setting device 11 to request the example of display shown in FIG. 3, the data setting device 11 reads the content of defective weaving of the last several number of operations and the like from the storing means 5 and displays them on the screen display unit 10. In this example, the time of the occurrence of defective weaving, the loom stoppage time, the content of stoppage of loom (content of defective weaving), step number (weft picking number) of the latest and the past defective weaving are listed in a vertical direction on the screen in the descending order, or inverse order. For example, in the case of FIG. 3, since the step numbers at the time of occurrence of either mispick are the same although the cause of the stoppage of the loom by the past five times is mispick of the weft of the same color 1, the true cause of the stoppage of the loom is conjectured to be affected to some extent by the device which is switched in operation modes by the step number. In such a manner, if information concerning operation modes and information concerning the defective weaving are listed in time line, the true cause of the stoppage of the loom can be easily identified without relying on the memory of an operator.

When the defective weaving occurs by the number exceeding the number of storage capacity of the storing means 5, the oldest content of defective weaving is deleted from the storing means 5, and the rest content of defective weaving and the like are moved down one by one, and the latest content of defective weaving and the like are newly stored.

The operation modes of devices on the loom relative to the defective weaving are put in the shape as follows. For example, when mispick in the loom having different colors of wefts occurs, the operation mode of the picking device 18 relating to the picking is a weft selection instruction, more in detail, the weft selection instruction includes the weft insertion condition selected by the same instruction, namely, a jetting condition of the weft insertion nozzle (a timing, a pressure) an amount of winding of weft in a measuring storage device, a cancel timing and the like. Further, the shed-forming device 17 associated with a weft running area and the operation modes of the selvage device when the mispick occurs is a shedding pattern (a shedding instruction relative to the heddle frame), more in detail, they include the amount of shedding and the height of the heddle frame. The operation mode in the let-off motion is a set tension selection instruction in the case where a set warp tension is switched during the operation of the loom, more in detail, the set tension selection instruction includes a set warp tension, a set tension pattern, and the like, and the operation mode of the main shaft driving unit (main shaft speed controller 20) is a revolution selection instruction, more in detail, the revolution selection instruction includes a set revolution, a revolution variation pattern and the like. Furthermore, the operation modes of the cloth fell moving device of a pile loom is a cloth fell moving instruction, and more in detail, the cloth fell moving instruction includes the amount of movement of the cloth fell and the like. Still furthermore, the operation mode in the shed-forming device 17 associated with a warp tension when the warp is broken is a shedding pattern, the amount of shedding, the height of heddle frame and the like in the same manner as set forth above, and the operation mode in the warp let-off motion is a warp set tension and the like while the operation mode in the cloth fell device in a pile loom is the amount of movement of the cloth fell and the like.

According to the first and fourth aspects of the invention, when the defective weaving occurs in the loom for switching the operation modes of the devices on the loom in response to the number of weft picking number, since wherein information concerning defective weaving when it occurs during weaving and information concerning operation modes of the devices on the loom when the defective weaving occurs are displayed, it is possible to make the right decision as to whether the cause of the defective weaving arising from the yarns or devices on the loom. Accordingly, if there is a doubt that the cause of the defective weaving resides at the device side, it can be easily made a short list of the portions to be checked from the display of the operation modes, and hence the cause of the defective weaving can be promptly identified. As a result, it is possible to prevent such an inconvenience in advance that the productivity of the cloth is lowered and the quality of the fabric is deteriorated for a long period of time by the continuous operation of the loom without identifying the causes of the defective weaving.

According to the second and fifth aspects of the invention, information concerning the operation modes is weft picking number when the defective weaving occurs, and hence it is possible to easily identify the device which is switched in operation mode based on the picking number, thereby coping rapidly with such a defective weaving.

According to the third aspect of the invention, the information concerning the operation modes is the content of the operation instruction relative to the device on the loom when the defective weaving occurs, and hence it is possible to easily make a short list of the device to be checked based on the display of the content of the operation instruction when there is a doubt that the cause arises from the devices on the loom, thereby coping rapidly with such defective weaving.

According to the sixth aspect of the invention, since the display means reads the content of operation signals from the operation signal generation device when the defective weaving occurs when the sensor detects the defective weaving, and displays the content of operation signals as information concerning the operation modes, the operation modes of each device when the defective weaving occurs can be easily figured out, thereby rapidly coping with such defective weaving.

According to the seventh aspect of the invention, since the contents of operation signals relative to a plurality of devices are displayed on the same screen, the operation modes of these devices can be easily compared with one another, thereby easily predicting the defective weaving portion based on the switching condition in operation modes.

According to the eighth aspect of the invention, since the information concerning the content of the defective weaving which is detected by the sensor and the information concerning the operation mode of the devices on the loom are stored in the storing means for the multiple number of times, it is possible to easily decide as to whether the defective weaving occurs continuously or not without relying on the memory of an operator, thereby rapidly identifying the device which is switched in operation mode.

According to the ninth aspect of the invention, since the information concerning the operation modes when the defective weaving occurs and the information concerning the operation modes immediately before the defective weaving occurs are displayed on the same screen, thereby easily identifying the device which is switched in operation modes in the temporal passage.

The disclosure of Japanese Patent Application No. 2002-261288 including specification, claims, and drawings, is incorporated herein by reference.

What is claimed is:

1. A method of displaying defective content of a loom for switching operation modes of devices on the loom in response to the weft picking number, wherein information concerning defective weaving when it occurs during weaving and information concerning operation modes of the devices on the loom when the defective weaving occurs are displayed.

2. The method according to claim 1, wherein the information concerning operation modes is the weft picking number when the defective weaving occurs.

3. The method according to claim 1, wherein the information concerning operation modes of the devices on the loom when the defective weaving occurs is a content of operation instruction output to the devices on the loom when the defective weaving occurs.

4. A display unit of a loom for switching operation modes of devices on the loom in response to the rotation of a main shaft of the loom comprising an operation signal generation means including an operation signal generation device for generating operation signals in response to operation modes of the devices on the loom based on the weft picking number which is counted with the rotation of the main shaft of a loom, and a display means for displaying information concerning content of defective weaving which is detected by a sensor and information concerning operation modes of the devices on the loom.

5. The display unit of a loom according to claim 4, wherein the information concerning operation modes displayed by the display means is the weft picking number when the defective weaving occurs.

6. The display unit of a loom according to claim 4 or 5, wherein the operation signal generation device outputs operation signals to the devices in response to the operation modes which are set corresponding to the weft picking number, and the devices are structured to switch the operation modes in response to the operation signals, while the display means reads the operation signals from the operation signal generation device when the sensor detects the defective weaving when the defective weaving occurs and displays it as the information concerning the operation modes.

7. The display unit of a loom according to claim 4, 5 or 6, wherein the display means displays the content of the operation signals supplied from the operation signal generation device to the devices on the same screen, said devices are switched in operation modes in response to the operation signals.

8. A display unit of a loom for switching operation modes of devices on the loom in response to the rotation of a main shaft of the loom comprising an operation signal generation means, storing means capable of storing a information concerning content of defective weaving and information concerning operation modes of the devices on the loom which are detected by the sensor, respectively, by multiple number of times, and display means for reading out and displaying thereon the content of defective weaving and information concerning operation modes of the devices on the loom.

9. The display unit of a loom according to claim 8, wherein the display means displays the information concerning operation modes of the devices on the loom when the defective weaving occurs and information concerning operation modes immediately before the defective weaving occurs, respectively when the sensor detects the information concerning content of defective weaving.
